(19) United States
(12) Patent Application Publication
(10) Pub. No.: US 2026/0327121 A1
(43) Pub. Date: Oct. 22, 2026

(54) METHOD FOR THE TREATMENT OF COMPLEX WASTE

(71) Applicant: SUEZ INTERNATIONAL, Paris La Défense Cedex (FR)

(72) Inventors: Pierre-Emmanuel PARDO, Paris La Défense Cedex (FR); Safwan AL AYOUBI, Paris La Défense Cedex (FR)

(73) Assignee: SUEZ INTERNATIONAL, Paris La Défense Cedex (FR)

(21) Appl. No.: 18/997,925

(22) PCT Filed: Jul. 28, 2023
(86) PCT No.: PCT/EP2023/071019

§ 371 Date: Jan. 23, 2025

(30) Foreign Application Priority Data
Jul. 29, 2022 (FR) FR2207901

(51) Int. Cl. C02F 11/08; C02F 3/28; C02F 11/18; C02F 101/30; C10J 3/78

(52) U.S. Cl. CPC C02F 11/08; C02F 3/28; C02F 11/18; C10J 3/78; C02F 2101/30; C02F 2305/023; C10J 2300/1681

(57) ABSTRACT

The invention relates to a method for treating a mixture (M1), said method comprising:
a) A step of pressurizing mixture (M1), making it possible to obtain a mixture (M1p),
b) a step of heating mixture (M1p), making it possible to obtain a mixture (M2),
c) a step of separating mixture (M2) in order to obtain a stream (M3) enriched in inorganic matter and a stream (M4) depleted of inorganic matter,
d) a hydrothermal gasification step carried out on at least one fraction of stream (M4), in order to obtain a mixture (M5) comprising gas and a liquid effluent,
e) a step of cooling and separating mixture (M5) making it possible to obtain a gas (M6) and a liquid effluent (M7),
said method further comprising at least one step of injecting at least one oxidant into at least one stream selected from:
at least one fraction of stream (M3), making it possible to obtain a stream (M3′),
at least one fraction of stream (M4), making it possible to obtain a stream (M4′), and
at least one fraction of liquid effluent (M7), making it possible to obtain a stream (M7′).

### TECHNICAL FIELD OF THE INVENTION

The invention relates to the field of treating complex waste, comprising organic and inorganic matter, such as aqueous waste, bioresource digestate (biomass) and sewage sludge.

### STATE OF THE ART

The treatment of complex waste requires high temperatures and consequently high energy costs.

Hydrothermal gasification is a process that typically involves subjecting biomass to high temperatures and high pressures. It therefore requires a high energy consumption, particularly in terms of heat.

To reduce the energy consumption of this process, systems are available to recover heat from the reaction output products in order to preheat the inputs. However, these heat recovery systems face a number of problems:
Cost problem: the high-grade steel surface required for these heat recovery systems is very expensive.
Clogging problem: heat exchangers are subject to regular clogging.
Thermal non-homogeneity problem: the poor heat conduction of the biomass leads to temperature dispersions within the waste itself.
“Pinch” problem: these heat recovery systems cannot recover all the heat from the output product as the temperature difference between the temperature of the input product and the temperature of the output product must be high enough not to lead to an “infinite” exchanger.
In addition, this pinch problem also occurs at supercritical temperatures as for these temperatures, a small temperature increase leads to a large energy difference, therefore the two hot and cold products will have a zone where the two products are close in temperature.

In addition, in order to heat the temperature residual due to pinch (when 2 streams are too close in temperature, heat exchange is not performed well), the gases produced to burn them are often used and then the combustion heat is recovered.

The invention proposes a method for treating complex waste with improved management of energy consumption, particularly of heat throughout the method, while maintaining high waste recovery efficiency.

### SUMMARY OF THE INVENTION

The invention relates to a method for treating a mixture M1 comprising at least organic matter, said method comprising:
a) A step of pressurizing mixture M1 to a pressure of 150 to 350 bar, making it possible to obtain a mixture M1p,
b) a step of heating mixture M1p to a temperature ranging from 200° C. to 500° C., making it possible to obtain a mixture M2,
c) a step of separating mixture M2 in order to obtain a stream M3 enriched in inorganic matter and a stream M4 depleted of inorganic matter,
d) a hydrothermal gasification step carried out on at least one fraction of stream M4 depleted of inorganic matter, in order to obtain a mixture M5 comprising gas and a liquid effluent,
e) a step of cooling and separating mixture M5, making it possible to obtain a gas M6 and a liquid effluent M7,
said method further comprising at least one step of injecting at least one oxidant into at least one stream selected from:
at least one fraction of stream M3 enriched in inorganic matter, preferably all of stream M3, making it possible to obtain a stream M3′,
at least one fraction of stream M4 depleted of inorganic matter, preferably all of stream M4, making it possible to obtain a stream M4′, and
at least one fraction of liquid effluent M7, preferably all of the liquid effluent M7, making it possible to obtain a stream M7′.

According to one embodiment, the method of the invention further comprises at least one step f) of recovering the heat present in at least one oxidized stream selected from M3′ or M7′.

According to one embodiment, the method of the invention further comprises, upstream of step a):
a step of hydrolyzing mixture M1 at a temperature ranging from 70 to 165° C. and at a pressure ranging from 2 to 8 bar, in order to obtain a mixture M1h, and/or
a step of mechanical grinding of mixture M1 or M1h.

According to one embodiment of the method of the invention, said at least one heat recovery step f) is carried out using a heat exchanger between oxidized stream M3′ or M7′ and mixture M1, M1h or M1p.

According to one embodiment, the method of the invention further comprises at least one other injection of oxidant carried out:
In mixture M1, and/or
Optionally in mixture M1h, and/or
Optionally in mixture M1 during the hydrolysis step, and/or
in mixture M1p upstream of step b), and/or
in mixture M1p during step b), and/or
in mixture M2 upstream of step c).

According to one embodiment of the method of the invention, mixture M1 comprises from 5 to 50% by weight of solids, preferably from 15 to 25% by weight of solids, with respect to the total weight of mixture M1.

According to one embodiment of the method of the invention, mixture M1 comprising at least organic matter further comprises phosphorus, the stream enriched in inorganic matter M3 from step c) then comprising phosphorus, the phosphorus being recovered with a yield of at least 70%.

According to one embodiment of the method of the invention, the oxidant is selected from liquid oxygen, hydrogen peroxide, air, permanganate salts such as potassium permanganate.

According to one embodiment of the method of the invention, the oxidant is added in a stoichiometric proportion ranging from 5% to 200% with respect to the organic matter.

According to one embodiment, the method of the invention comprises:
a heat exchange between mixture M5 and mixture M1p, making it possible on the one hand to cool mixture M5 in step e) and on the other hand to heat mixture M1p,
a step of injecting at least one oxidant into the liquid effluent M7 in order to obtain an oxidized stream M7′,
an exchange of heat between the oxidized stream M7′ and mixture M1, M1h or M1p, making it possible on the one hand to cool the oxidized stream M7′ and on the other hand to heat mixture M1, M1h or M1p, preferably M1p in step b).

According to one embodiment, the method of the invention further comprises a step of digesting at least one fraction of stream M7 or M7″ obtained by cooling stream M7′, preferably at least one fraction of stream M7″ obtained by cooling stream M7′.

Preferably, the digestion step is anaerobic digestion.

The invention also relates to an installation for implementing the treatment method according to the invention, said installation comprising:
a pressurization pump 3 supplied with mixture M1 or optionally with the hydrolyzed mixture which is optionally ground and comprising an outlet for mixture M1p,
a heating device 4 comprising an inlet for introducing at least one fraction of mixture M1p downstream of the pump 3,
a separation device 5 supplied with at least one fraction of the heated mixture from the heating device 4 and comprising an outlet for a stream M3 enriched in inorganic matter and an outlet for a stream M4 depleted of inorganic matter,
a hydrothermal gasification reactor 8 supplied with at least one fraction of stream M4 from the separation device 5 and comprising an outlet for mixture M5 comprising gas and a liquid effluent,
A separation device 9 downstream of the gasification reactor 8, supplied with at least one fraction of the pre-cooled mixture M5, and comprising at least one outlet for a gaseous effluent M6 and at least one outlet for a liquid effluent M7,
At least one oxidant injection device located:
   in the line of stream M3 enriched in inorganic matter or in an oxidation reactor supplied with stream M3,
   in the line of stream M4, and/or
   in the line of stream M7.

According to one embodiment, the installation of the invention further comprises:
one or more hydrolysis reactors 1 optionally comprising a stirring device, supplied at the inlet by a feed line for mixture M1 to be treated and comprising an outlet line for the hydrolyzed mixture M1h, and
optionally, a mechanical grinding device supplied by the outlet line for the hydrolyzed mixture M1h and comprising an outlet line for the hydrolyzed and ground mixture,
optionally at least one heat exchange device 10 between at least one of streams M3 and/or M7 downstream of the injection device and at least one stream selected from M1, M1h, M1p or M2.

According to one embodiment, the installation of the invention comprises:
At least one device for injecting oxidant into the line of stream M7 in order to obtain an oxidized stream M7′, and
A heat exchange means for recovering heat from mixture M5 and transferring it to mixture M1p, and
A heat exchange means for recovering heat from stream M7′ and transferring it to mixture M1, M1h or M1p,
it being understood that one of the two heat exchange means may be constituted by the heating device 4.

The invention improves the treatment of an organic matter in a complex matrix. Improved treatment allows better recovery on the one hand of inorganic matter, such as salts, and on the other hand of organic matter.

By virtue of the method according to invention, on the one hand, part of the organic matter is burnt directly in the system to produce the required temperature in situ, therefore consuming less carbon than in an external combustion system to achieve the same result, and on the other hand, this combustion will be precisely controlled to manage the temperatures. Finally, this internal combustion will be integrated with heat recovery both by limiting costs by virtue of increased viscosity and by virtue of displacing the pinch.

Additionally, the hydrothermal conditions combined with an oxidant produce this internal combustion reaction.

Finally, in the hydrothermal gasification processes, a step of separating the inorganic matter takes place, taking advantage of the supercritical conditions that allow the inorganic matter to be insolubilized and therefore recovered separately. However, it is technologically complicated to recover pure inorganic matter. Along with this inorganic matter, a significant amount of water must be evacuated, which is still bound to unreacted organic matter.

By virtue of the method of the invention, the injection of oxidant into this organic matter in several steps of the method releases heat and produces an inorganic residue that is purified from this organic matter and therefore more reusable.

The configuration of the method proposed in this invention makes it possible, in an inventive way, to integrate all of the problems of the state of the art identified by the inventors.

### BRIEF DESCRIPTION OF THE FIGURES

FIG. 1 is a schematic representation of a treatment method according to the invention.

FIG. 2 is a schematic representation of a treatment method according to the invention.

FIG. 3 is a schematic representation of a treatment method according to the invention.

FIG. 4 is a schematic representation of a treatment method according to the invention.

FIG. 5 is a schematic representation of a treatment method according to the invention.

FIG. 6 is a schematic representation of a treatment method according to the invention.

FIG. 7 is a schematic representation of a treatment method according to the invention.

### DETAILED DESCRIPTION OF THE INVENTION

The invention relates to a method for treating a mixture M1 comprising at least organic matter, said method comprising:
a. A step of pressurizing mixture M1 to a pressure of 150 to 350 bar, preferably between 200 and 250 bar, making it possible to obtain a mixture M1p,
b. a step of heating mixture M1p to a temperature ranging from 200° C. to 500° C., preferably from 250° C. to 350° C., making it possible to obtain a mixture M2,
c. a step of separating mixture M2 from step b) in order to obtain a stream M3 enriched in inorganic matter and a stream M4 depleted of inorganic matter,
d. a hydrothermal gasification step carried out on at least one fraction of stream M4 depleted of inorganic matter, preferably on all of stream M4, in order to obtain a mixture M5 comprising gas and a liquid effluent,
e. a step of cooling and separating mixture M5, making it possible to obtain a gas M6 and a liquid effluent M7,
said method further comprising at least one step of injecting at least one oxidant into at least one stream selected from:
at least one fraction of stream M3 enriched in inorganic matter, preferably all of stream M3,
at least one fraction of stream M4 depleted of inorganic matter, preferably all of stream M4,
at least one fraction of liquid effluent M7, preferably all of liquid effluent M7.

Typically, the addition of the oxidant into a stream will generate exothermic oxidation reactions in said stream, thus producing an oxidized stream.

Thus, according to one embodiment, the method according to the invention further comprises at least one step f) of recovering the heat present in at least one oxidized stream (stream obtained after injection of the oxidant) selected from streams M3′ or M7′.

According to a preferred embodiment, the method comprises at least one step of injecting an oxidant into at least one fraction of stream M3 enriched in inorganic matter, preferably all of stream M3, making it possible to obtain an oxidized stream M3′. Preferably, according to this embodiment, the method further comprises at least one step of recovering the heat emitted during oxidation of stream M3 to at least partially heat mixture M1 upstream of the heating step b). Thus, it can be mixture M1, M1h or M1p.

According to a preferred embodiment, the method comprises at least one step of injecting an oxidant into at least one fraction of stream M7, preferably all of stream M7, making it possible to obtain an oxidized stream M7′. Preferably, according to this embodiment, the method further comprises at least one step of recovering the heat emitted during oxidation of stream M7′ to at least partially heat mixture M1 upstream of the heating step b). Thus, it can be mixture M1, M1h or M1p.

For the purposes of the present invention, the expression “at least one fraction of a mixture or stream” has the same meaning as the expression “all or part of said mixture or stream”. In the case of a part of said mixture or of said stream, this expression refers to a certain proportion of said mixture or said stream. For example, for the purposes of this expression, “each fraction of the mixture” or “each fraction of the stream” will have the same composition.

Thus, for the purposes of the present invention, the expression “step X carried out on all of stream M from step Y” means that steps X and Y are successive and that there is no intermediate separation step between steps X and Y, it being understood that there could be cooling/heating of stream M between steps X and Y, in particular by heat exchange which could optionally involve an exchange of streams.

### Mixture M1 Comprising at Least Organic Matter

Mixture M1 comprises at least organic matter. Typically, mixture M1 further comprises inorganic matter. Inorganic matter includes salts comprising anions such as phosphates, sulfates, chlorides, carbonates and hydrocarbonates with counterions such as sodium, magnesium, calcium, ammonium and metals.

Mixture M1 may for example be selected from primary, mixed or biological sludge from municipal and industrial wastewater treatment plants.

According to one embodiment, mixture M1 comprises from 5 to 50% by weight of solids, preferably from 15 to 25% by weight of solids, with respect to the total weight of mixture M1.

### Possible Hydrolysis Step

According to one embodiment, the method according to the invention comprises a hydrolysis step of mixture M1, carried out upstream of the pressurization step a).

The hydrolysis step is carried out at a temperature ranging from 70 to 165° C. and at a pressure ranging from 2 to 8 bar.

The hydrolysis step reduces the viscosity of the mixture. Thus, the possible hydrolysis step produces a mixture M1h also known as hydrolysate.

The hydrolysis step allows the organic matter to be broken down, in particular by breaking the chemical bonds and depolymerizing the organic matter through the effect of water.

Mixture M1h will typically have a viscosity at least 2 times lower, preferably at least 4 times lower, even more preferably at least 10 times lower than the viscosity of mixture M1.

Thus, the ratio between the viscosity of mixture M1 and the viscosity of mixture M1h is at least 2, preferably at least 4, even more preferably at least 10.

The viscosity defined in the context of the present invention is a kinematic viscosity measured at the same temperature (for example 20° C.) using rheometers adapted to the viscosity to be measured (cylinder-cylinder, plane-plane) and by measuring the two viscosities at the same shear rate (in s⁻¹), typically taking care to eliminate turbulence problems and to comply with rheological rules (for example, spacing between cylinders based on particle size).

The hydrolysis step carried out on mixture M1 can be carried out in one or more hydrolysis reactors in parallel or in series.

Said hydrolysis step allows mixture M1 to be hydrolyzed notably by maintaining an average hydraulic residence time at the desired temperatures and pressures (preferably temperatures ranging from 70 to 165° C. and pressures ranging from 2 to 8 bar), it being understood that if the hydrolysis step is carried out in several hydrolysis reactors, the temperature may be identical or different in the different reactors, and similarly, the pressure may be identical or different in the different reactors.

Advantageously, the hydrolysis step will carry out an internal energy recovery step, thus minimizing the heat consumption of hydrolysis. For example, there could be an energy recirculation loop from the hot hydrolysate to the cold product to be hydrolyzed, for example, by production of steam for expansion of the hot hydrolysate and injection into the cold product to be hydrolyzed or heat exchange.

At the end of the hydrolysis step, a hydrolysate M1h is obtained, which is not necessarily at the desired temperatures and pressures for hydrolysis. Indeed, before the end of the hydrolysis step, the hydrolysate may optionally undergo a cooling and/or expansion step.

In particular, for example if hydrolysis is carried out at a high temperature, for example ranging from 100 to 165° C., then it may be desirable to cool the hydrolysate to a temperature below 90° C. for example, so that stream M1h has a lower temperature for pressurization in step a) of the method of the invention.

Extraction of the hydrolysate M1h can be controlled by measuring viscosity.

According to one embodiment, an additive is added to mixture M1 to be treated before entering the hydrolysis device.

According to one embodiment, a controlled amount of steam can be injected into the hydrolysis reactor(s) and diffused through mixture M1. This control can be carried out by measuring the temperature in the hydrolysis reactor. Once the setpoint temperature has been reached, steam injection can be stopped.

Steam can be injected:
upstream of hydrolysis into the inlet with a dynamic mixer type mixer, and/or
directly in the hydrolysis reactor, preferentially in the lower part in a tangential manner to avoid clogging by sludge, and/or
in a hydrolyzed sludge recirculation loop.

According to one embodiment, during hydrolysis, mixture M1 is mixed, for example it is stirred.

The hydrolysis reactor may be a batch reactor, which is optionally stirred.

Prior to pressurization, the treatment method may optionally comprise a grinding step, preferably mechanical grinding.

When present, the step of grinding mixture M1 may be carried out before, during or after hydrolysis. In the latter case, grinding is then carried out on mixture M1h.

When the method of the invention carries out a hydrolysis step combined with a grinding step, then the method of the invention may optionally comprise a step of recirculating at least one fraction of the ground hydrolysate at the start of the hydrolysis step.

According to one embodiment, the hydrolysis reactor(s) comprise(s) a recirculation loop equipped with a grinding device, allowing at least one fraction of the hydrolysate to be introduced into said grinding device and at least one fraction, preferably all, of the hydrolysate thus ground to be returned to the start of the hydrolysis step.

The purpose of this grinding step is to reduce the particle size of mixture M1, typically so that the particle size of the solid fraction is less than 1000 μm, preferably less than 500 μm and more preferably less than 100 μm.

A particle size “less than X μm” means that 95% of solid particles are retained on a sieve with a square mesh size of X μm and that the remaining 5% are no larger than 3 times X μm.

In addition to the reduction in particle size, which minimizes downstream clogging, the grinding step homogenizes mixture M1 and reduces the viscosity thus allowing much better control of the process parameters for hydrothermal gasification.

Like the hydrolysis step, grinding and particle size reduction also contribute to biomass homogenization.

In high-pressure reactors, it is difficult to achieve mechanical stirring, and the viscosity reduction achieved by virtue of the hydrolysis step further improves internal turbulence and therefore homogenization in pressurized reactors.

### Pressurization Step a)

The method according to the invention comprises a step of pressurizing mixture M1, where applicable hydrolyzed mixture M1 (referred to as mixture M1h), at a pressure ranging from 150 to 350 bar, preferably 200 to 250 bar.

Pressurization is carried out upstream of heating step b) to avoid vaporization of the mixture.

For the pressurization step, a pump may be provided on the line at the outlet of the hydrolysis reactor when it is present.

In another embodiment, a dedicated pump supplies the pressurization pump.

In the context of the present invention, the expression “where applicable M1h” means that the characteristic applies only if the hydrolysis step is present, since if it is not carried out, stream M1h does not exist.

### Heating Step b)

The method according to the invention comprises a step of heating mixture M1 to a temperature ranging from 200 to 500° C., preferably ranging from 250 to 350° C.

According to an embodiment carrying out a hydrolysis step, said heating step is preferably carried out downstream of the pressurization step.

According to an embodiment carrying out a grinding step, said heating step is preferably carried out downstream of the pressurization step.

At least part of the heating of mixture M1 (or M1h if hydrolysis) can be carried out in a heat exchanger, for example by heat exchange using the heat recovered in heat recovery step f) in at least one oxidized stream.

Thus, a heat exchanger may be present (downstream of the pressurization pump), said heat exchanger being configured to recover the heat emitted during the oxidation step following the addition of at least one oxidant and to heat mixture M1 prior to the separation step c) or mixture M1h if a hydrolysis step is present.

According to one embodiment, an oxidant is further added to at least one stream selected from mixture M1, where applicable M1h, mixture M1p and mixture M2.

According to one embodiment, the oxidant is selected from oxidizing agents such as liquefied oxygen, hydrogen peroxide, air, permanganate salts such as potassium permanganate.

### Separation Step c)

The method according to the invention comprises a step of separating mixture M2 from step b), in order to obtain a stream M3 enriched in inorganic matter and a stream M4 depleted of inorganic matter.

For the purposes of this invention, “stream enriched in inorganic matter” means a stream comprising a mass proportion of inorganic matter greater than the mass proportion of inorganic matter in mixture M2.

For the purposes of the present invention, “stream depleted of inorganic matter” means a stream comprising a mass proportion of inorganic matter lower than the mass proportion of inorganic matter in mixture M2.

According to one embodiment, the ratio between the concentration of inorganic matter in the enriched stream M3 and the concentration of inorganic matter in mixture M2 is at least 2, preferably at least 5.

The separation step is typically carried out in a separation device comprising a feed line for mixture M2 from step a) and two outlet lines: (i) a line for extracting the stream enriched in inorganic matter M3 and (ii) a line for extracting the stream depleted of inorganic matter M4.

The separation device may be a gravitational or hydraulic cyclone-type separation device typically fitted at the bottom with a continuous or intermittent discharge system.

According to one embodiment, mixture M1 comprises phosphorus and the stream enriched in inorganic matter M3 from step c) comprises at least 70% by weight of the total weight of phosphorus present in mixture M1. In other words, at least 70% by weight of the phosphorus present in mixture M1 is recovered in the stream enriched in inorganic matter M3 from step c).

According to one embodiment, mixture M1 comprises phosphorus and the stream enriched in inorganic matter M3 from step c) comprises phosphorus, preferably in a proportion ranging from 1 to 20% by dry weight, with respect to the total dry weight of the stream enriched in inorganic matter M3 from step c).

### Injection of Oxidant

The treatment method according to the invention comprises at least one step of injecting at least one oxidant.

According to one embodiment, said at least one oxidant is selected, inter alia, from liquid oxygen, hydrogen peroxide, air, permanganate salts such as potassium permanganate.

Injection can be carried out directly in the stream line or in an oxidation reactor, preferably, the oxidant is injected directly into the stream line and oxidation is preferably carried out directly in-line (without a specific device such as an oxidation reactor).

When an oxidation reactor is used, the oxidant can be injected either into the stream line upstream of the reactor or into the reactor. According to this embodiment, the residence time in the oxidation reactor can range from 1 to 300 seconds.

Typically, the amount of oxidant can be adjusted based on the oxidation objective. Thus, if oxidation is carried out for heating, then the amount of oxidant can be adjusted based on the desired temperatures. If oxidation is carried out to destroy the organic matter and produce a mineral-free organic matter, the oxidant will be used in excess and the amount of excess need not be controlled. If oxidation is carried out to make the organic matter more easily digestible, then the amount of oxidant can be adjusted based on the digestibility of the effluent, as measured by the amount of total organic carbon (TOC) that can be measured downstream of the digestion process.

Preferably, the oxidant is added to at least one of the streams selected from stream M3, stream M4 and stream M7 in a stoichiometric proportion ranging from 5% to 200% with respect to the organic matter.

When heat recovery is carried out, oxidation allows better management of energy resources.

In addition to the injection(s) of oxidant defined previously, the method according to the invention may also comprise one or more other oxidant injections.

Thus, according to one embodiment, the method further comprises at least one injection of oxidant into at least one stream selected from:
the stream of mixture M1, and/or
the mixture during an optional hydrolysis step of mixture M1, and/or
the stream of mixture M1h downstream of an optional hydrolysis step, and/or
the stream of mixture M1p downstream of pressurization a) and upstream of heating b), and/or
mixture M1p during heating step b), and/or
the stream of mixture M2 downstream of heating step b) and upstream of step c),
preferably selected from:
the stream of mixture M1, and/or
the stream of mixture M1h downstream of an optional hydrolysis step, and/or
the stream of mixture M1p downstream of pressurization a) and upstream of heating b), and/or
the stream of mixture M2 downstream of heating step b) and upstream of step c).

According to one embodiment, the method comprises an injection of oxidant into at least one fraction of stream M3 enriched in inorganic matter, preferably into all of stream M3.

Preferably, the oxidant is added to stream M3 in a stoichiometric proportion ranging from 30% to 200% with respect to the organic matter, preferably from 100 to 200% with respect to the organic matter.

The addition of the oxidant oxidizes stream M3 in order to obtain an oxidized stream M3′.

When carried out on at least one fraction of stream M3 in order to obtain oxidized stream M3′, such oxidation notably makes it possible to eliminate residual organic matter in order to obtain a more easily recoverable stream of inorganic matter.

Oxidation “burns” the organic matter present with the mineral matter in stream M3, which then produces a more “mineral” stream that is easier to separate by precipitation/crystallization, for example.

Thus, according to one embodiment, it will be possible to provide a step of adding an additive to the oxidized stream M3′ and a step of recovering the salts. For example, the additive may be a magnesium salt and the recovery step may be a struvite precipitation step. The magnesium salt can be selected from MgO, Mg(OH)2, MgCl2.

According to one embodiment, said oxidant injection step is carried out in at least one fraction of stream M4 depleted of inorganic matter.

The addition of the oxidant oxidizes stream M4 in order to obtain an oxidized stream M4′.

In particular, such an injection of oxidant will notably allow stream M4 to be heated upstream of the hydrothermal gasification step d), thus minimizing the need for external heating sources or heat exchange, and thus reducing the size of the heat exchangers.

The proportion of oxidant can be controlled, for example, by the target temperature after oxidation. Thus, temperature sensors may be present in-line downstream of the oxidant injection points. Control units can thus adjust the amount of oxidant injected based on the temperature measurement downstream of the oxidant injection points.

Preferably, the oxidant is added to stream M4 in a stoichiometric proportion ranging from 5% to 50% with respect to the organic matter, preferably from 5 to 20% with respect to the organic matter.

According to one embodiment, said oxidant injection step is carried out in at least one fraction of the liquid effluent M7.

In particular, such an injection of oxidant will destroy undesirable compounds that are refractory to digestion and thus convert part of the non-digestible molecules into digestible molecules. Organic matter is said to be “refractory” if it cannot be aerobically destroyed by bacteria during a 20-day residence time.

Additionally, such an injection will increase the temperature of this stream M7 and therefore better heat mixture M1, M1h, M2 during an optional heat recovery step.

Additionally, since stream M7 is colder than stream M5, injecting an oxidant into stream M7, rather than into stream M5, ensures that the temperature does not rise too high (and therefore reduces equipment stress) and means that the CH4 produced during hydrothermal gasification is not burned.

Thus, the hydrothermal gasification step, followed by the cooling and separation step, coupled with the oxidant injection step in the downstream liquid stream (stream M7) allows better management of the matter, both thermally and in terms of treatment, in order to facilitate any subsequent digestion.

Preferably, the oxidant is added to stream M7 in a stoichiometric proportion ranging from 5% to 100% with respect to the organic matter, preferably from 20 to 90% with respect to the organic matter.

The addition of the oxidant oxidizes stream M7 in order to obtain an oxidized stream M7′.

When used in mixture M1, M1h, M1p or M2, the injection of oxidant allows the matter to be heated with minimal heat exchange, thus optimizing energy expenditure and the size of the exchangers.

According to this embodiment with the addition of oxidant(s) in at least one of streams M1, M1h, M1p or M2, preferably the oxidant is selected, inter alia, from liquid oxygen, hydrogen peroxide, air, permanganate salts such as potassium permanganate.

Preferably, the oxidant is added to at least one of the streams selected from stream M1 or M1h, or stream M1p (before, during or after heating step b)) and stream M2 in a stoichiometric proportion ranging from 5% to 50% with respect to the organic matter, preferably from 5 to 20% with respect to the organic matter.

According to one embodiment, the residence time of the oxidant in the stream considered (M1, M1h, M1p, M2, M3, M4 and/or M7) typically ranges from 1 second to 5 minutes.

### Hydrothermal Gasification Step d)

The treatment method according to the invention comprises a hydrothermal gasification step carried out on the stream depleted of inorganic matter M4 in order to obtain a gas and a stream comprising inorganic matter and organic matter.

Hydrothermal gasification (HG) is a thermal depolymerization process used to convert organic matter present in a humid environment into a mixture comprising only small molecules under high to moderate temperature and pressure.

During the HG process, the carbon and hydrogen in an organic matter are converted thermochemically under near-critical or supercritical conditions. Part is converted into water-soluble compounds with low molar masses.

Another part is converted into gaseous products such as carbon dioxide (CO2), methane (CH4), dihydrogen (H2), carbon monoxide (CO), light hydrocarbons such as ethane (C2H6) and propane (C3H8).

During residence in the hydrothermal gasification reactor at temperatures less than 400° C., the organic matter undergoes, among other reactions, hydrolysis-based decomposition, similar to the reactions occurring in the liquefaction process, but much more rapidly. In fact, implementation under near-critical or supercritical conditions makes it possible to use the unique properties of supercritical water as a solvent, allowing homogeneous solvation and reaction conditions, leading to very high reaction kinetic speeds. As a result, a much shorter residence time and a much higher heating rate than in conventional hydrolysis are used, limiting or even avoiding the secondary condensation and polymerization reactions responsible for bio-oil and bio-char formation.

When the HG operates at temperatures above 400° C., radical decomposition of polymers (involving in particular decarboxylation, deamination reactions by breaking C—N bonds, and C—C or C—O cleavage) predominates, while endothermic steam reforming is the main reaction pathway for converting small molecules with 1 to 3 carbon atoms into carbon oxides and dihydrogen, and nitrogen into ammonia.

Methane is also produced by the methanation of CO and CO2, using dihydrogen.

As a result, HG can be seen as a decomposition process transforming the organic residues present in stream M4 into a more readily biodegradable material and into ammonia dissolved in the liquid phase.

The treatment conditions (in particular temperature, pressure, and to a lesser extent residence time) of the HG can be adjusted to not only produce a gaseous fraction containing CH4, CO, CO2 and H2 (synthesis gas), but also to produce an aqueous effluent, containing mainly easily digestible compounds, notably carboxylic acids, on the one hand, and ammonia in the form of the ammonium salt of the carbonic acids produced, on the other hand.

It should be noted that HG is different from hydrothermal liquefaction (HTL), in particular in that the conversion rate and level of decomposition of organic matter in HTL are not as high as in HG, even when HG is operated under moderate temperature conditions.

Under HTL conditions, the water still contains HO− and H3O+ ions which initiate the hydrolysis of organic matter.

Hydrolysis only takes place on the surface of the cellulose compounds contained in the organic fraction which dissolves very little in the subcritical medium, resulting in fairly low decomposition conversions.

Condensation reactions (comprising mainly Aldol condensation, alkylation or Friedel-Craft acylation) of intermediates are an important reaction pathway, leading to the formation of biocrude which is an oil (also called bio-oil) that can be used as a fuel, that is, biocrude contains organic molecules containing 5 or more carbon atoms, generally from 8 to 16 carbon atoms. The liquid product of HG, on the other hand, contains mainly readily biodegradable compounds.

HG differs from pyrolysis in that it is carried out in a medium containing water, the water being in a supercritical or near-critical state.

HG differs from “conventional” gasification of organic matter in that “conventional” gasification reduces the carbon/hydrogen (C/H) mass ratio, resulting in products with increased calorific value, including a gas composed mainly of synthesis gas (H2/CO mixture), bio-oil and/or carbonaceous solid (char).

The presence of an oxidizing agent introduced into one of streams M1, M1h, M1p, M2, M3, M4, M7 produces exothermic combustion mechanisms even from sub-critical conditions, thus accelerating the decomposition reactions and producing excess heat that raises the temperature of the medium faster than heating by heat exchange.

In the treatment method according to the invention, the hydrothermal gasification step is typically carried out in a hydrothermal gasification reactor, supplied at the inlet by the stream depleted of inorganic matter M4 and comprising an outlet for mixture M5 comprising gas and a liquid effluent, the liquid effluent then typically comprising organic matter and inorganic matter.

According to one embodiment, the gasification reactor is a tubular reactor.

The gasification reactor may optionally comprise a catalyst. Preferably, the gasification reactor is catalyst-free.

Preferably, the hydrothermal gasification step is carried out at a temperature less than 600° C., preferably at a temperature ranging from 350° C. to less than 600° C., even more preferably ranging from 450 to less than 600° C.

Preferably, the hydrothermal gasification step is carried out at a pressure greater than or equal to 220 bar, preferably greater than or equal to 250 bar.

Preferably, the (overall) residence time of the stream depleted of inorganic matter M4 in HG step e) typically ranges from 1 min to 20 min, preferably from 2 min to 10 min, more preferably from 3 to 5 min.

### Cooling and Separation Step e)

The treatment method according to the invention comprises a step of cooling and separating at least one fraction of mixture M5 resulting from the hydrothermal gasification of step d) in order to obtain a gaseous effluent M6 and a liquid effluent M7.

The cooling step brings mixture M5 to a temperature less than or equal to 250° C.

If the method does not involve injecting oxidant into stream M7, then according to a preferred embodiment, the cooling step will bring mixture M5 to a temperature less than or equal to 200° C., preferably less than or equal to 120° C., and even more preferably ranging from 50 to 120° C..

If the method involves at least one injection of oxidant into stream M7, then according to a preferred embodiment, the cooling step will bring mixture M5 to a temperature ranging from 180° C. to 250° C., preferably ranging from 190 to 230° C.

The cooling device can be selected from a heat exchanger, flash, scrubber or Rankine cycle.

According to an advantageous embodiment, the cooling step is carried out by heat exchange, thus allowing mixture M1p to be at least partially heated during heating step b). According to this embodiment, heating step b) and cooling step d) are carried out in the same heat exchanger. Mixture M5 then transfers heat in order to heat mixture M1p.

According to one embodiment, the method does not comprise any injection of oxidant into stream M7 and according to this embodiment, preferably, the method will comprise, in addition to an exchange of heat between mixture M5 and mixture M1p (corresponding to a first cooling step of mixture M5), a second cooling step in a cooling device, preferably a heat recovery device, downstream of the first cooling step and upstream of the step of separating mixture M5 (in order to obtain stream M6 and stream M7).

According to one embodiment, the (cooled) stream M5 is expanded in an expansion device up to a pressure ranging from 0 to 2 bar (relative). This expansion step recovers, on the one hand, the gases M6 and, on the other hand, a liquid effluent M7. According to this embodiment, the liquid effluent from the expansion process can be used to supply a digestion device.

### Heat Recovery f)

The treatment method according to the invention optionally comprises at least one step of recovering the heat emitted during the oxidation of at least one oxidized stream selected from M3′ or M7′, in order to at least partially heat mixture M1, where applicable M1h or M1p.

According to one embodiment, heat recovery step f) is carried out using a heat exchanger.

According to one embodiment, heat recovery in step f) is carried out by means of direct heat exchange between the oxidized stream and mixture M1 or M1h if hydrolysis has been carried out or with mixture M1p.

“Direct heat exchange” is the opposite of “indirect heat exchange”. Heat exchange is said to be indirect when a heat transfer fluid is used to recover heat from a “hot” stream in order to transfer it to another “cold” stream.

In contrast, heat exchange is said to be direct when heat from a “hot” stream is transferred directly to a “cold” stream, without intermediate heat transfer fluid.

According to one embodiment, heat recovery in step f) is carried out by indirect heat exchange between the oxidized stream M3′ or M7′ and mixture M1, where applicable M1h or M1p, by means of a heat transfer circuit in which an intermediate heat transfer fluid circulates, said fluid recovering heat from the oxidized stream in order to transfer it to mixture M1, where applicable M1h or M1p.

If the method implements at least one injection of oxidant into stream M7, then preferably, oxidized stream M7′ is then cooled, preferably by heat exchange with at least one stream implemented in the method.

According to one embodiment, before any digestion, the heat present in stream M7 is recovered, said recovered heat preferably allowing at least partial heating of mixture M1, where applicable M1h, M1p, M2 and/or M4, preferably M1, where applicable M1h, M1p.

Preferably, this heat recovery is carried out by heat exchange between stream M7 and mixture M1, M1h or M1p. Thus, the heat present in stream M7 can be transferred to at least one of the streams selected from M1, M1h, M1p.

According to one embodiment, an oxidant is added to stream M7 prior to such heat exchange. Indeed, the oxidation of stream M7 will further heat stream M7, called M7′ after oxidation, and therefore improve heat exchange between stream M7′ and one of the streams selected from M1, M1h, M1p, M2, preferably M1 or M1h or M1p.

Preferably, after cooling stream M7′, for example by virtue of heat exchange as described hereinbefore, the method further comprises (downstream of cooling M7′) a step of separating the cooled stream M7′ making it possible to obtain CO2 on the one hand and stream M7″ on the other hand. This separation step reduces the CO2 content, or even eliminates the CO2, present in the cooled stream M7′. Said stream M7″, after said CO2 separation, can then be used as an input of a digester and undergo digestion.

According to an advantageous embodiment, the treatment method according to the invention comprises:
a heat exchange between mixture M5 mixture and mixture M1 or where applicable M1h or M1p, making it possible on the one hand to cool mixture M5 (step e)) and on the other hand to heat mixture M1 or M1h or M1p,
a step of injecting at least one oxidant into the liquid effluent M7 in order to obtain an oxidized stream M7′,
a heat exchange between the oxidized stream M7′ and mixture M1 or where applicable M1h or M1p, making it possible on the one hand to cool stream M7′ and on the other hand to heat mixture M1 or M1h or M1p.

According to an advantageous embodiment, the treatment method according to the invention comprises:
a heat exchange between mixture M5 and mixture M1p, making it possible on the one hand to cool mixture M5 (step e)) to a temperature ranging from 180 to 250° C., and on the other hand to heat mixture M1p,
a step of injecting at least one oxidant into the liquid effluent M7 in order to obtain an oxidized stream M7′ having a temperature ranging from 200 to 350° C.,
a heat exchange between the oxidized stream M7′ and mixture M1 or where applicable M1h or M1p, making it possible on the one hand to cool oxidized stream M7′ to a temperature less than or equal to 200° C., preferably less than or equal to 120° C., more preferably less than or equal to 60° C., and on the other hand to heat mixture M1 or M1h or M1p.

According to an advantageous embodiment, the treatment method according to the invention comprises:
a heat exchange between mixture M5 mixture and mixture M1 or where applicable M1h or M1p, making it possible on the one hand to cool mixture M5 (step e)) and on the other hand to heat mixture M1 or M1h or M1p,
a step of injecting at least one oxidant into the liquid effluent M3 in order to obtain an oxidized stream M3′,
a heat exchange between the oxidized stream M3′ and mixture M1, M1h, M1p, making it possible on the one hand to cool stream M3′ and on the other hand to heat mixture M1 or M1h or M1p.

According to one embodiment, the treatment method according to the invention comprises:
a heat exchange between mixture M5 and mixture M1p, making it possible on the one hand to cool mixture M5 (step e)) to a temperature ranging from 180 to 250° C., and on the other hand to heat mixture M1p,
a step of injecting at least one oxidant into the liquid effluent M7 in order to obtain an oxidized stream M7′ having a temperature ranging from 200 to 350° C.,
a step of injecting at least one oxidant into the liquid effluent M3 in order to obtain an oxidized stream M3′,
a heat exchange between the oxidized stream M3′ and mixture M1, M1h, M1p, making it possible on the one hand to cool stream M3′ and on the other hand to heat mixture M1 or M1h or M1p.
a heat exchange between the oxidized stream M7′ and mixture M1 or where applicable M1h or M1p, making it possible on the one hand to cool oxidized stream M7′ to a temperature less than or equal to 200° C., preferably less than or equal to 120° C., more preferably less than or equal to 60° C., and on the other hand to heat mixture M1 or M1h or M1p.

The invention also relates to an installation for implementing the method according to the invention.

The installation according to the invention comprises:
optionally one or more hydrolysis reactors 1 optionally comprising a stirring device, supplied at the inlet by a feed line for mixture M1 to be treated and comprising an outlet line for the hydrolyzed mixture M1h,
optionally, a mechanical grinding device supplied by the outlet line for the hydrolyzed mixture M1h and comprising an outlet line for the hydrolyzed and ground mixture,
a pressurization pump 3 supplied by mixture M1 or optionally by the hydrolyzed mixture which is optionally ground and comprising an outlet for mixture M1p,
a heating device 4 comprising an inlet for introducing at least one fraction of mixture M1p downstream of the pump 3,
a separation device 5 supplied with at least one fraction of the heated mixture from the heating device 4 and comprising an outlet for a stream M3 enriched in inorganic matter and an outlet for a stream M4 depleted of inorganic matter,
a hydrothermal gasification reactor 8 supplied by at least one fraction of stream M4 from the separation device 5 and comprising an outlet for mixture M5 comprising gas and a liquid effluent,
A separation device 9 downstream of the gasification reactor 8, supplied by at least one fraction of the pre-cooled mixture M5, and comprising at least one outlet for a gaseous effluent M6 and at least one outlet for a liquid effluent M7,
At least one oxidant injection device located:
   in the line of stream M3 enriched in inorganic matter or in an oxidation reactor supplied with stream M3,
   in the line of stream M4, and/or
   in the line of stream M7.

Optionally a heat exchange device between at least one of streams M3′ and/or M7′ downstream of the injection device and at least one stream selected from M1, M1h, M1p or M2.

According to one embodiment of the invention, the installation comprises at least one hydrolysis reactor 1 upstream of the pressurization pump 3.

Indeed, the installation according to the invention may comprise one or more hydrolysis reactors 1 in series or in parallel, supplied at the inlet by a feed line for mixture M1 and an outlet line for the hydrolyzed mixture M1h at a temperature less than or equal to the hydrolysis temperature. The hydrolysis reactor(s) 1 advantageously comprise(s) a heating and pressurization device and optionally comprise(s) a stirring device, as well as advantageously an internal heat recovery device.

The hydrolysis reactor(s) 1 may optionally be preceded by a grinding device or may be provided with a recirculation loop equipped with a grinding device or may be followed by a grinding device, upstream of the pump 3.

The installation according to the invention may further comprise a cooling device 9′ supplied by at least one fraction of mixture M5, upstream of the separation device 9.

According to one embodiment of the installation, the heating device 4 is a heat exchanger making it possible to cool mixture M5 upstream of the separation device 9, or when present, upstream of the cooling device 9′.

The installation according to the invention may optionally comprise a digestion device supplied by at least one fraction of a stream M7″ obtained after cooling stream M7′.

According to one embodiment, the installation according to the invention comprises at least one device for injecting oxidant into the line of stream M7 and the cooling device 9′ and the heating device 4 are one and the same heat exchanger, so that the cooled stream M5 from said heat exchanger then supplies the separation device 9.

According to one embodiment, the hydrolysis reactor is a heat exchanger making it possible to recover heat from at least one of the oxidized streams M3′ and/or M7′ in order to transfer it to mixture M1 during hydrolysis.

According to one embodiment, the installation further comprises at least one heat exchanger 10 separate from the heating device 4, making it possible to recover heat from at least one of the oxidized streams M3′ and/or M7′ in order to transfer it to mixture M1p.

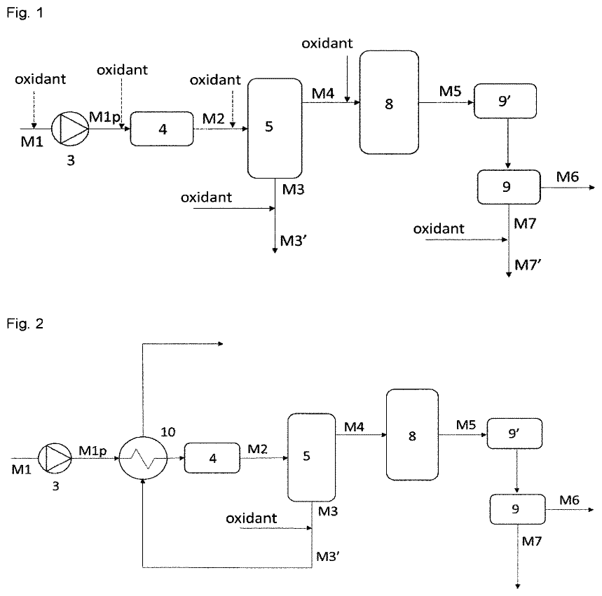

FIGS. 1 to 7 each show an embodiment of the method and of the installation according to the invention, without limiting the scope thereof.

Referring to the diagram in FIG. 1, mixture M1 is pressurized using a pump 3 before being introduced into a heating device 4 to obtain a mixture M2.

Mixture M2 is introduced into a separation device 5 making it possible to obtain a stream M3 enriched in inorganic matter and a stream M4 depleted of inorganic matter.

Stream M4 from the separation device 5 is introduced into a hydrothermal gasification reactor 8 making it possible to obtain a mixture M5.

Mixture M5 can then be introduced into a cooling device 9′ before being separated in a separation device 9 in order to obtain a gaseous stream M6 and a liquid effluent M7.

The installation of FIG. 1 has several oxidant injection points and therefore several injection devices. It should be noted that the installation according to the invention comprises at least one device for injecting oxidant into at least one of streams M3, M4 and/or M7 (solid arrow on FIG. 1).

The installation according to the invention may further comprise at least one device for injecting oxidant into at least one of streams M1, M1p or M2 (dashed arrow on FIG. 1).

FIG. 2 shows an embodiment of the invention where the method comprises an injection of oxidant into stream M3 and at least one step of recovering heat from oxidized stream M3′ by virtue of a heat exchanger 10 located downstream of the pump 3 and upstream of the heating device 4.

The oxidized stream M3′ may optionally supply a precipitation or crystallization reactor, after any addition of an additive to selectively precipitate a product. For example, a magnesium salt may be added to stream M3′ in order to form struvite in a precipitation reactor.

Of course, other oxidant injection points may be provided in the embodiment of FIG. 2, in accordance with the injection points shown in particular in FIG. 1.

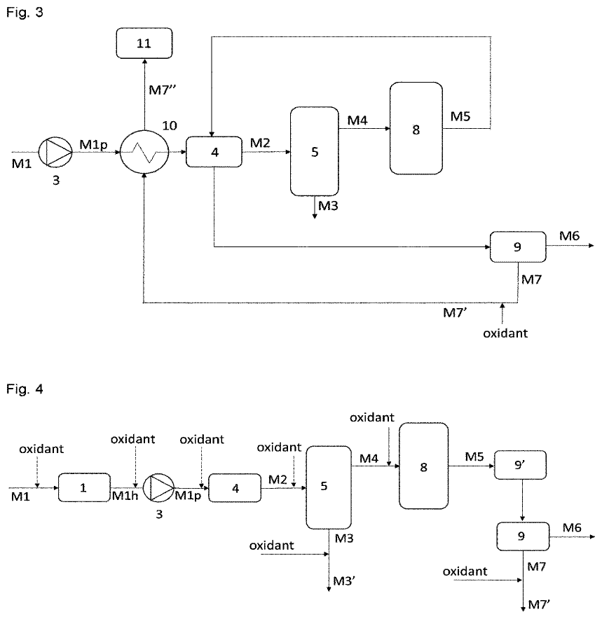

FIG. 3 shows an embodiment of the invention where the method comprises an injection of oxidant into stream M7 and at least one step of recovering heat from the oxidized stream M7′ in a heat exchanger 10 downstream of the pressurization pump 3 thus making it possible to heat mixture M1p upstream of the heating device 4. According to this embodiment, the heating device 4 is a heat exchanger which cools mixture M5 (in step e)) and heats mixture M1p in step b). According to this embodiment, the cooled mixture M5 is then introduced into a separation device 9. Also according to this embodiment, the stream M7″ cooled downstream of the heat exchanger 10 is introduced into a digester 11. This embodiment is shown in FIG. 3.

Of course, other oxidant injection points may be provided in the embodiment of FIG. 3, in accordance with the injection points shown in particular in FIG. 1.

FIG. 4 differs from FIG. 1 in that a hydrolysis reactor 1 is shown. Thus, according to one embodiment, the installation comprises a hydrolysis reactor 1 supplied by mixture M1 and comprising an outlet for the hydrolysate M1h. According to this embodiment, an oxidant may also be injected into stream M1h.

FIG. 5 shows an embodiment of the invention where the method comprises a preliminary step of hydrolyzing the mixture M1 in a hydrolysis reactor 1 upstream of pressurization in the pump 3. In the embodiment shown in FIG. 5, the method comprises at least one injection of oxidant into stream M3 in order to obtain an oxidized stream M3′ and at least one step of recovering heat from the oxidized stream M3′ in order to transfer it to mixture M1 during the hydrolysis step, in which case the hydrolysis reactor 1 may be a heat exchanger.

Of course, other oxidant injection points may be provided in the embodiment of FIG. 5, in accordance with the injection points shown in particular in FIG. 4.

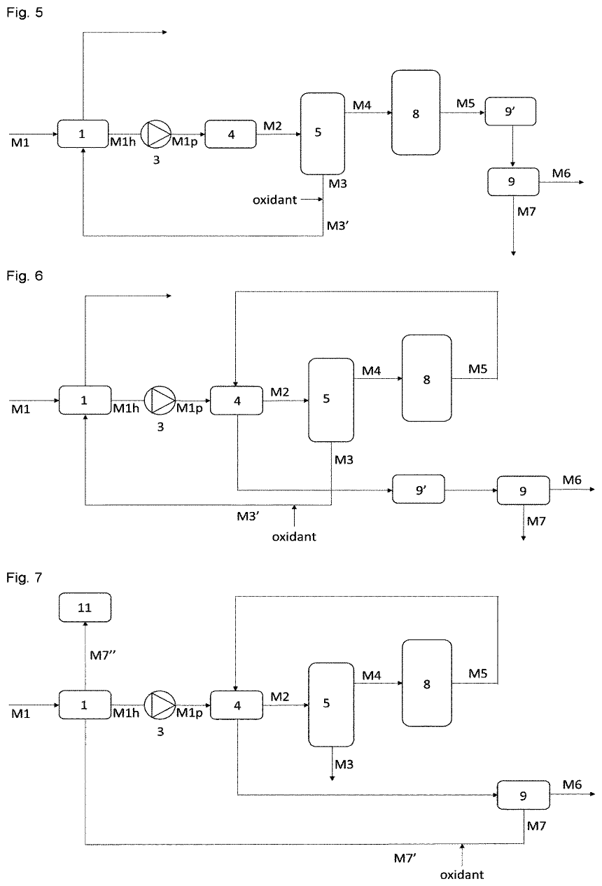

FIG. 6 differs from FIG. 5 in that the heating device 4 is a heat exchanger which cools mixture M5 (in step e)) and heats mixture M1p in step b). According to the embodiment shown in FIG. 6, cooling step e) and heating step b) are carried out in a heat exchanger 4. According to this embodiment shown in FIG. 4, the installation comprises a cooling device 9′ downstream of the heat exchanger 4 to further cool mixture M5, upstream of the separation device 9. This embodiment is particularly advantageous when the installation does not comprise an oxidant injection device on stream M7 downstream of the separation device 9.

Thus, the cooled mixture M5 is then introduced into a separation device 9.

FIG. 7 differs from FIG. 6 in that the oxidant is injected into stream M7 and in that the oxidized stream M7′ is used to heat mixture M1 during the hydrolysis step 1. Also according to this embodiment, the stream M7″ cooled downstream of the heat exchanger 10 is introduced into a digester 11.

The installation according to the invention may of course comprise one or more of the features described as part of the method according to the invention.

1. A method for treating a mixture M1 comprising at least organic matter, the method comprising:
a) pressurizing the mixture M1 to a pressure of 150 to 350 bar, to obtain a mixture M1p:
b) heating mixture M1p to a temperature ranging from 200° C. to 500° C., to obtain a mixture M2;
c) separating mixture M2 to obtain a stream M3 enriched in inorganic matter and a stream M4 depleted of inorganic matter;
d) carrying out hydrothermal gasification on at least one fraction of stream M4 depleted of inorganic matter, to obtain a mixture M5 comprising gas and a liquid effluent;
e) of cooling and separating mixture M5, to obtain a gas M6 and a liquid effluent M7; and
at least one step of injecting at least one oxidant into at least one stream selected from:
at least one fraction of stream M3 enriched in inorganic matter to obtain a stream M3′,
at least one fraction of stream M4 depleted of inorganic matter to obtain a stream M4′, and
at least one fraction of liquid effluent M7 to obtain a stream M7′.

2. The method according to claim 1, further comprising:
f) at least one step of recovering the heat present in at least one oxidized stream selected from M3′ and M7′.

3. The method according to claim 1, further comprising, upstream of step a):
hydrolyzing mixture M1 at a temperature ranging from 70 to 165° C. and at a pressure ranging from 2 to 8 bar, to obtain a mixture M1h, and/or
mechanical grinding of mixture M1 or M1h.

4. The method according to claim 2, wherein the at least one heat recovery step f) is carried out with a heat exchanger between the oxidized stream M3′ or M7′ and the mixture M1, M1h, or M1p.

5. The method according to claim 1, further comprising:
injecting oxidant
in mixture M1, and/or
in mixture M1h, and/or
in mixture M1 during the hydrolysis step, and/or
in mixture M1p upstream of step b), and/or
in mixture M1p during step b), and/or
in mixture M2 upstream of step c).

6. The method according to claim 1, wherein the mixture MI comprises from 5 to 50% by weight of solids with respect to the total weight of mixture M1.

7. The method according to claim 1, wherein the mixture M1 comprising at least organic matter further comprises phosphorus, the stream enriched in inorganic matter M3 from step c) then comprising phosphorus, the phosphorus being recovered with a yield of at least 70%.

8. The method according to claim 1, wherein the oxidant is selected from liquid oxygen, hydrogen peroxide, and a permanganate salt.

9. The method according to claim 1, wherein the oxidant is added in a stoichiometric proportion ranging from 5% to 200% with respect to the organic matter.

10. The method according to claim 1, further comprising:
exchanging heat between mixture M5 and mixture M1p to cool mixture M5 in step e) and to heat mixture M1p;
injecting at least one oxidant into the liquid effluent M7 to obtain an oxidized stream M7′; and
exchanging heat between the oxidized stream M7′ and mixture M1, M1h, or M1p, to cool the oxidized stream M7′ and to heat mixture M1, M1h, or M1p.

11. The method according to claim 1, further comprising:
digesting at least one fraction of stream M7 or M7″ obtained by cooling stream M7′.

12. The method according to claim 11, wherein the digesting is an anaerobic digestion.

13. An installation for implementing the method of claim 1, the installation comprising:
a pressurization pump supplied by mixture M1 or by the hydrolyzed mixture, optionally ground, and comprising an outlet for mixture M1p:
a heating device comprising an inlet for introducing at least one fraction of mixture M1p downstream of the pump;
a separation device supplied with at least one fraction of the heated mixture from the heating device and comprising an outlet for a stream M3 enriched in inorganic matter and an outlet for a stream M4 depleted of inorganic matter;
a hydrothermal gasification reactor supplied by at least one fraction of stream M4 from the separation device and comprising an outlet for mixture M5 comprising gas and a liquid effluent;
a separation device downstream of the gasification reactor, supplied by at least one fraction of the pre-cooled mixture M5, and comprising at least one outlet for a gaseous effluent M6 and at least one outlet for a liquid effluent M7; and
at least one oxidant injection device located:
in the line of stream M3 enriched in inorganic matter or in an oxidation reactor supplied with stream M3,
in the line of stream M4, and/or
in the line of stream M7.

14. The installation according to claim 13, further comprising:
one or more hydrolysis reactors supplied at the inlet by a feed line for mixture M1 to be treated and comprising an outlet line for the hydrolyzed mixture M1h.

15. The installation according to claim 13, further comprising:
at least one device suitable for injecting oxidant into the line of stream M7 in to obtain an oxidized stream M7′;
a first heat exchange means suitable for recovering heat from mixture M5 and transferring it to mixture M1p; and
a second heat exchange means suitable for recovering heat from stream M7′ and transferring it to mixture M1, M1h, or M1p.

16. The installation according to claim 13, wherein the one or more hydrolysis reactors comprises a stirring device.

17. The installation according to claim 13, further comprising:
a mechanical grinding device supplied by the outlet line for the hydrolyzed mixture M1h and comprising an outlet line for the hydrolyzed and ground mixture.

18. The installation according to claim 13, further comprising:
at least one heat exchange device between at least one of streams M3 and/or M7 downstream of the injection device and at least one stream selected from M1, M1h, M1p, or M2.

19. The installation according to claim 15, wherein the heating device provides one of the first and second heat exchange means.
